(19) United States
(12) Patent Application Publication
(10) Pub. No.: US 2025/0134292 A1
(43) Pub. Date: May 1, 2025

(54) A System For Delivering Food To A Customer And A Method Thereof

(71) Applicant: CLEAN EATS & CO PTE. LTD., Singapore (SG)

(72) Inventor: Tristan Lo, Singapore (SG)

(21) Appl. No.: 18/835,833

(22) PCT Filed: Feb. 3, 2023
(86) PCT No.: PCT/SG2023/050061

§ 371 Date: Aug. 5, 2024

(30) Foreign Application Priority Data
Feb. 4, 2022 (SG) 10202201080W

(51) Int. Cl. A47G 29/28; A47G 29/30; A47J 39/02

(52) U.S. Cl. CPC A47G 29/28; A47G 29/30; A47J 39/02; A47G 2200/20

(57) ABSTRACT

A system for delivering food to a customer is provided. The system includes a food container adapted to open on one side of the food container or another side opposite the one side, a detector configured to detect that the food has been removed from the food container, a processing unit including a processor, a memory in communication with the processor, the memory for storing instruction executable by the processor, the processor is configured to receive an instruction from a customer's device to open the food container on the one side, such that the one side faces the customer, wherein the customer is able to collect the food from the food container, detect the food is removed from the food container, and close the food container on the one side and open the food container on the another side automatically, wherein the another side faces a kitchen where food is placed into the food container from the kitchen.

### CROSS-REFERENCE TO RELATED APPLICATIONS

The present application is a national phase entry under 35 U.S.C. § 371 of International Patent Application No. PCT/SG2023/050061, filed Feb. 3, 2023, designating the United States of America and published in English as International Patent Publication No. WO 2023/149843 on Aug. 10, 2023, which claims the benefit of Singapore Patent Application No. 10202201080W filed Feb. 4, 2022; which is incorporated by reference herein.

### TECHNICAL FIELD

The present invention relates to a system for delivering food to a customer and a method thereof. Preferably, the present invention relates to an automated system for delivering food to the customer.

### BACKGROUND

The current problem faced by the industry is that human service is necessary for food to be delivered or served at a counter. Humans can transfer contagious diseases and during times of a pandemic, the problem of handling food safely becomes a pertinent issue. F&B and service industries are coping with these challenges by adapting their services accordingly.

An attempt to address this problem was in the form of automated machines that are prevalent in the market such as instant coffee makers. However these machines still have to be manually operated.

It would be advantageous for a solution to address the abovementioned problem.

### SUMMARY

According to various embodiments, a system for delivering food to a customer is provided. The system includes a food container adapted to open on one side of the food container or another side opposite the one side, a detector configured to detect that the food has been removed from the food container, a processing unit including a processor, a memory in communication with the processor, the memory for storing instruction executable by the processor, the processor is configured to receive an instruction from a customer's device to open the food container on the one side, such that the one side faces the customer, wherein the customer is able to collect the food from the food container, detect the food is removed from the food container, and close the food container on the one side and open the food container on the another side automatically, wherein the another side faces a kitchen where food is placed into the food container from the kitchen.

According to various embodiments, the food container may include a housing for containing the food, the housing may include a cover adapted to be displaced from a front side of the housing to a rear side of the housing opposite the front side, wherein when the cover is at the front side of the housing, the food container is open at the another side of the food container and when the cover is at the rear side of the housing, the food container is open at the one side of the food container.

According to various embodiments, to detect the food is removed from the food container, the detector may include configured to detect the presence of the customer's hand in the food container.

According to various embodiments, the detector may include configured to detect the presence of the food in the food container.

According to various embodiments, the system may further include a heating element adapted to heat or a chilling element adapted to chill the food in the food container.

According to various embodiments, the processor may be further configured to close the food container after a pre-determined period of time.

According to various embodiments, a method for delivering food to a customer is provided. The method includes receiving an instruction from a customer's device to open the food container on the one side, such that the one side faces the customer, such that the customer is able to collect the food from the food container, such that the food container adapted to open on the one side of the food container or another side opposite the one side, detecting the food is removed from the food container, and closing the food container on the one side and opening the food container on the another side automatically, such that the another side faces a kitchen where food is placed into the food container from the kitchen.

According to various embodiments, the food container includes a housing for containing the food, the housing may include a cover, such that the method may include displacing the cover from a front side of the housing to a rear side of the housing opposite the front side, such that when the cover is at the front side of the housing, the food container is open at the another side of the food container and when the cover is at the rear side of the housing, the food container is open at the one side of the food container.

According to various embodiments, detecting the food is removed from the food container may include detecting the presence of the customer's hand in the food container.

According to various embodiments, detecting the food is removed from the food container may include detecting the presence of the food in the food container.

According to various embodiments, the method may further include heating or chilling the food in the food container.

According to various embodiments, the method may further include closing the food container after a pre-determined period of time.

According to various embodiments, a non-transitory computer readable storage medium comprising instructions, such that the instructions, when executed by a processor in a system, cause the system to receive an instruction from a customer's device to open the food container on the one side, such that the one side faces the customer, such that the customer is able to collect the food from the food container, detect the food is removed from the food container, and close the food container on the one side and open the food container on the another side automatically, such that the another side faces a kitchen where food is placed into the food container from the kitchen.

### BRIEF DESCRIPTION OF DRAWINGS

FIG. 1 shows an exemplary embodiment of a system for delivering food to a customer.

FIG. 2 shows an exemplary flowchart of a method for delivering food to a customer.

FIG. 3A shows an exemplary embodiment of a premise for delivering the food, e.g. a restaurant.

FIG. 3B shows an exemplary embodiment of the food container.

FIG. 4 shows a flow diagram of a method of delivering food to the customer.

FIG. 5 shows an exemplary embodiment of the food container.

### DETAILED DESCRIPTION

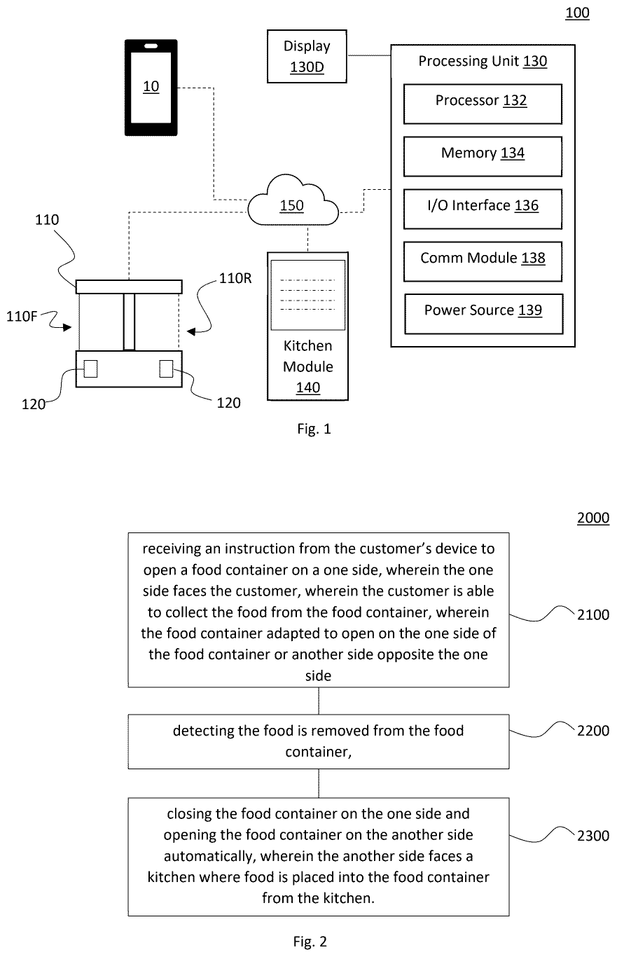

FIG. 1 shows an exemplary embodiment of a system 100 for delivering food to a customer. System 100 includes a food container 110 adapted to open on one side 110F of the food container 110 or another side 110R opposite the one side 110F, a detector 120 configured to detect that the food has been removed from the food container 110, a processing unit 130 including a processor 132, a memory 134 in communication with the processor 132, the memory 134 for storing instruction executable by the processor 132, the processor 132 is configured to receive an instruction from a customer's device 10 to open the food container 110 on the one side 110F, such that the one side 110F faces the customer, such that the customer is able to collect the food from the food container 110, detecting the food is removed from the food container 110, closing the food container 110 on the one side 110F and opening the food container 110 on the another side 110R automatically, such that the another side 110R faces a kitchen where food is placed into the food container 110 from the kitchen. System 100 may include a display 130D connected to the processing unit 130 for displaying a graphical user interface for interaction with the customer. System 100 may include a kitchen module 140 in communication with the processing unit 130. Kitchen module 140 may include a display for displaying a graphical user interface for interaction with the kitchen staff. Kitchen module 140 may be configured to receive orders from and transmit instruction to the processing unit 130. System 100 enables contactless delivery and can deliver meals faster, more efficiently and conveniently, with a superior customer experience.

Processing unit 130 may further include an I/O interface 136, a communication module 138 and a power source 139. Processing unit 130 is configured to communicate with the device 10, the kitchen module 140 and the food container 110 via a network 150. Customer's device 10 may include a mobile phone, a laptop, a tablet, etc. and be equipped with a camera. Kitchen module 140 may include a tablet, a laptop, a touchscreen, etc.

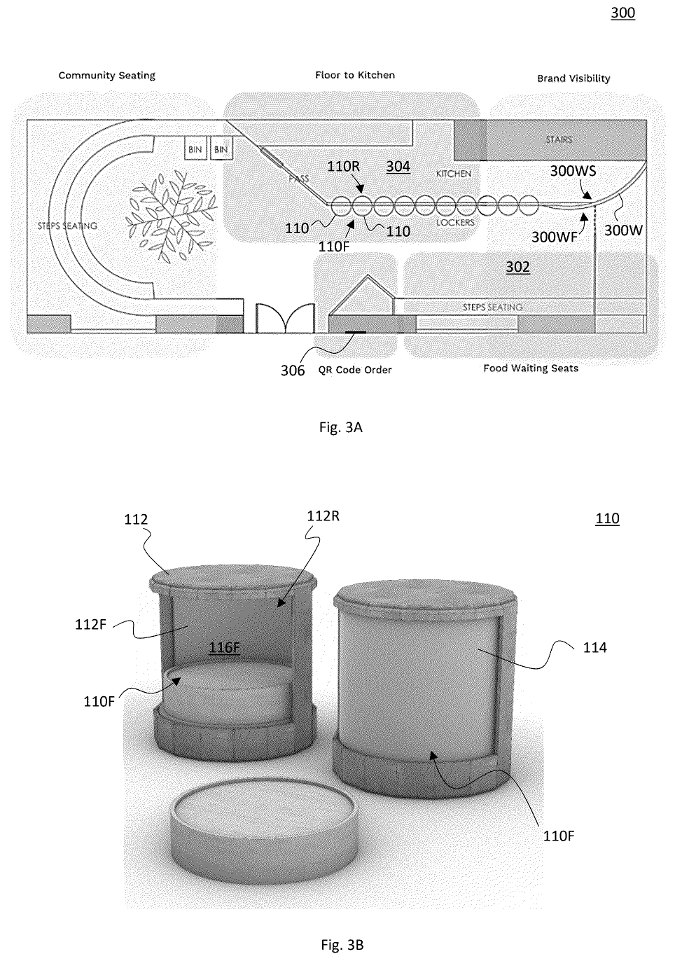

FIG. 2 shows a flowchart of an exemplary method 2000 for delivering food to a customer. Method includes receiving an instruction from the customer's device 10 to open the food container 110 on the one side 110F in block 2100, such that the one side 110F faces the customer and the customer is able to collect the food from the food container 110. Method includes detecting the food is removed from the food container 110 in block 2200, closing the food container 110 on the one side 110F and opening the food container 110 on the another side 110R automatically in block 2300, such that the another side 110R faces a kitchen where food is placed into the food container 110 from the kitchen.

FIG. 3A shows an exemplary embodiment of a premise 300 for delivering the food, e.g. a restaurant, cafe. Premise 300 may include a waiting area 302 where the customers wait for the food to be delivered and a kitchen 304 where the food is prepared. Premise 300 may include a plurality of the food containers 110. Plurality of food containers 110 may be disposed between the waiting area 302 and the kitchen 304. Each of the plurality of food containers 110 may be labelled. One side 110F of the food container 110 faces the waiting area 302, where the customers are waiting for the food and the another side 110R of the food container 110 faces the kitchen 304. Food container 110 is adapted to open either toward the customers or the kitchen 304. A wall 300W may be disposed between the waiting area 302 and the kitchen 304 and the plurality of food containers 110 may be disposed in the wall 300W such that the one side 110F of the food container 110 opens along a first side 300WF of the wall 300W facing the waiting area 302 and the another side 110R of the food container 110 opens along a second side 300WS of the wall 300W, opposite the first side 300WF, and faces the kitchen 304.

FIG. 3B shows an exemplary embodiment of the food container 110. Food container 110 may include a housing 112 for containing the food, the housing 112 may include a cover 114 adapted to be displaced from a front side 112F of the housing 112 to a rear side (not shown in FIG. 3B) of the housing 112 opposite the front side 112F, such that when the cover 114 is at the front side 112F of the housing 112, the food container 110 is open at the another side (not shown in FIG. 3B) of the food container 110 and when the cover 114 is at the rear side of the housing 112, the food container 110 is open at the one side 110F of the food container 110. When the cover 114 is at the front side 112F, a rear opening (not shown in FIG. 3B) is created at the rear side 110R of the housing 112, i.e. the food container 110 is open at the rear side 110R. When the cover 114 is at the rear side 110R, a front opening 116F is created at the front side 112F of the housing 112, i.e. the food container 110 is open at the front side 112F. When the cover 114 is displaced from the front side 112F of the housing 112 to the rear side, the front opening 116F is opened, and the rear opening is closed. Accordingly, the food container 110 is opened at the one side 110F and closed on the another side. When the cover 114 is displaced from the rear side of the housing 112 to the front side 112F, the rear opening is opened, and the front opening 116F is closed. Accordingly, the food container 110 is opened at the another side and closed on the one side 110F. In a sense, the food container 110 which is opened at one side 110F is “turned” to open toward the another side when the cover 114 is displaced from the rear side to the front side 112F of the housing 112. Referring to FIG. 3B, the one side 110F of the food container 110 may be the side facing the customer or waiting area 302 and the another side of the food container 110 may be the side facing the kitchen 304. Food container 110 may include an indicator, e.g. LED, (not shown in FIG. 3B) to indicate that the food is ready to be collected. Alternatively, the housing 112 may include a cover having two portions, i.e. a front portion and a rear portion such that the two portions may be opened and closed to reveal the front opening and the rear opening accordingly.

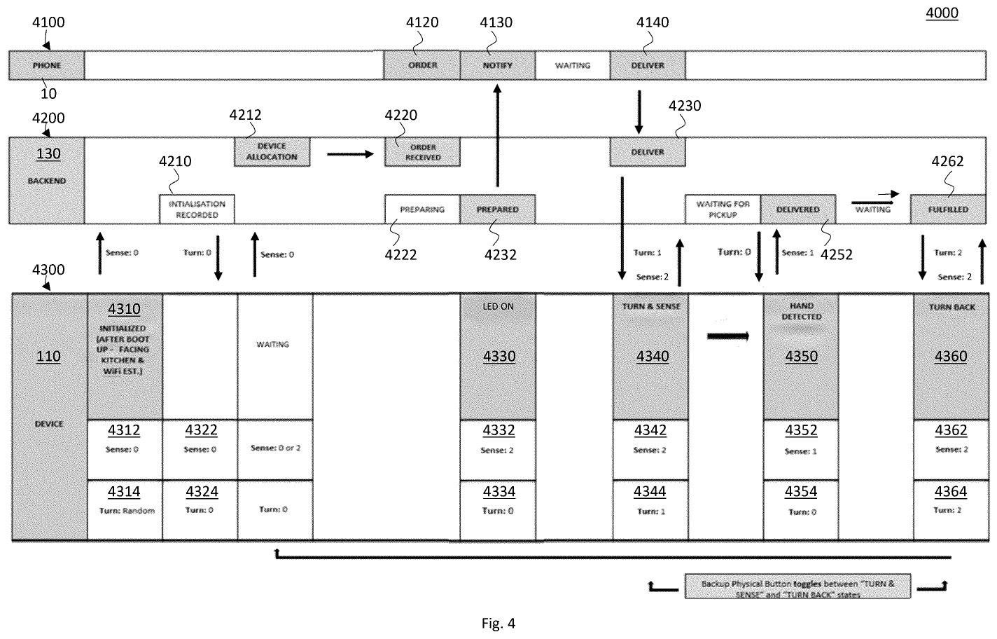

FIG. 4 shows a flow diagram 4000 of an exemplary method of delivering food to the customer. Flow diagram 4000 shows the flow of data and instruction between the customer's device 10, the processing unit 130 and the food container 110. Row 4100, 4200 and 4300 represents the process taken by the customer's device 10, the processing unit 130 and the food container 110 respectively.

System 100 may first initialize the food container 110 at Box 4310. At this step, the detector 120 is being initialized and the food container 110 may face the one side 110F or the another side 110R. “Sense” is a parameter to denote the status of the presence of the customer's hand in the food container 110 and may be toggled between status, “0”, “1” or “2”, where “0” represents the detector 120 is being initialized, “1” represents the detector 120 detects the customer's hand is in the food container 110, and “2” represents the detector 120 does not detect the customer's hand in the food container 110. “Turn” is a parameter to denote the status of the facing of the food container 110, i.e. whether the food container 110 is turned to face the customer or the kitchen 304, and may be toggled between status, “0”, “1” or “2”, where “0” represents the turning of the food container 110 is being disabled, “1” represents the food container 110 is facing the customer, and “2” represents the food container 110 is facing the kitchen 304. Therefore, as shown in Box 4312 and 4314, when the food container 110 is being initialized, the detector 120 is being initialized (Sense: 0) and the facing of the food holder may be random (Turn: Random), i.e. can be facing the customer or the kitchen 304. Processing unit 130 records the initialization at Box 4210 and the detector 120 remains initialized (Sense: 0) at Box 4322 and turning status of the food container 110 is “disabled” (Turn: 0) at Box 4324.

Customer may order the food via his or her device 10 or the display 130D. Customer may download an app into his or her device 10 or access a website on the device 10 or display 130D. In this example, the customer may access the system 100 via his or her device 10. The customer may scan a QR code 306 (shown in FIG. 3) displayed at the premise 300 to access the graphical user interface to communicate with the system 100. A menu may be displayed on the device 10.

Customer may place an order via the device 10 at Box 4120 and transmit the order to the processing unit 130. Processing unit 130, upon receiving the order at Box 4220, notifies the kitchen 304 via the kitchen module 140 to prepare the food according to the order and records the status that the food is being prepared at Box 4222. In the meantime, the processing unit 130 allocates the food container 110 for the order to be delivered to from the kitchen 304 at Box 4212. Once the food has been prepared, the kitchen staff may input the “prepared” status into the kitchen module 140 which in turn transmits the status to the processing unit 130, which records the status in Box 4232. Processing unit 130 then transmits the status to the customer's device 10 to notify the customer that the food has been prepared at Box 4130. Processing unit 130 may transmit the label of the food container 110 to the customer's device 10 to notify the customer the food container 110 that the food is contained in. At the same time, the processing unit 130 transmits instruction to the food container 110 to turn towards the kitchen 304, i.e. open the food container 110 toward the kitchen 304, for the kitchen staff to place the food into the food container 110. Customer's device 10 may display a “Open Food Container” button for the customer to click to open the food container 110. Meanwhile, the system 100 waits for the customer's further instruction. Processing unit 130 may turn on the indicator to indicate to the customer that the food is ready to be collected at Box 4330. At this point, the detector 120 status is changed to “Customer Hand not Detected” (Sense: 2) at Box 4332 and the turn status remains facing the kitchen 304 (Turn: 0) at Box 4334.

When the customer is ready to collect the food, the customer may instruct the system 100 to deliver the food by sending a deliver instruction to the processing unit 130 via the customer's device 10 at Box 4140, e.g. clicking the “Open Food Container” botton displayed on the device 10. Processing unit 130, upon receiving the deliver instruction at Box 4230, instructs the food container 110 to turn toward the customer at Box 4340 and await the food container 110 to return a detector status from the detector 120 of the food container 110. At this juncture, the food container 110 is turned to face the opening to customer (Turn: 1) at Box 4342 and the detector 120 has not detected the presence of the customer's hand (Sense: 2) at Box 4344. Food container 110 may be configured to close the food container 110 after a pre-determined period of time. e.g. 60 seconds, 30 seconds, 10 seconds, 5 seconds, etc.

Alternatively, the system 100 may include a token for activating the food container 110 for food collection and a reader for reading the token at each of the food container 110. Customer may be dispensed the token upon reaching the premise 300 and the customer may use the token at the reader of the food container 110 to turn the food container 110 to face the customer. Token may be an RFID tag and the reader may be an RFID transponder.

When the customer collects the food from the food container 110, the detector 120 detects that the customer's hand is present in the food container 110 in Box 4350. At this point, the detector 120 status is changed (Sense: 1) at Box 4352 and the turning of the food container 110 is disabled (Turn: 0) at Box 4354. Processing unit 130 may be configured to check the detector 120 status over a pre-determined period of time, e.g. 60 seconds, 30 seconds, 10 seconds, 5 seconds, etc. Alternatively, the food container 110 is configured to transmit the detector status to the processing unit 130 over the same pre-determined period of time. Upon receiving the detector status that the customer's hand has been detected or after a pre-determined period of time, the processing unit 130 records the food as delivered, i.e. collected by the customer, at Box 4252. Customer may notify the processing unit 130 via the device 10 that the food has been collected. Processing unit 130 may the record the food as delivered. As the detector 120 may be configured to detect the presence of the food in the food container 110, the processing unit 130 may be configured to request for the detector status to identify if the food is still in the food container 110. Alternatively, the processing unit 130 is configured to close the food container 110 after a pre-determined period of time. In other words, the food container 110 turns to face the kitchen 304 after the pre-determined period of time.

When the detector 120 no longer detects the presence of the customer's hand or the food, the detector 120 status is changed (Sense: 2) at Box 4362 and transmitted to the processing unit 130. Upon receiving the status, the processing unit 130 instructs the food container 110 to turn toward the kitchen 304 at Box 4360 and the turn status of the food container 110 is changed (Turn: 2) at Box 4364. At this point, the processing unit 130 records that the order has been fulfilled at Box 4262. Processing unit 130 may be configured to turn off the indicator to indicate that the food has been collected.

Whenever a food container 110 delivers the food to a customer, the processing unit 130 is configured to record the type of food delivered. Food may be served in pre-prepared bowls. Based on the data collected, the processing unit 130 is able to monitor the inventory level of the food accordingly. Hence, the system 100 allows monitoring of the rate of delivery of the food bowls and the remaining food bowls in each premise 300 and prepare the food bowls according to the demand and on time. In this way, the system 100 enables minimal food wastage and delivery of fresh food.

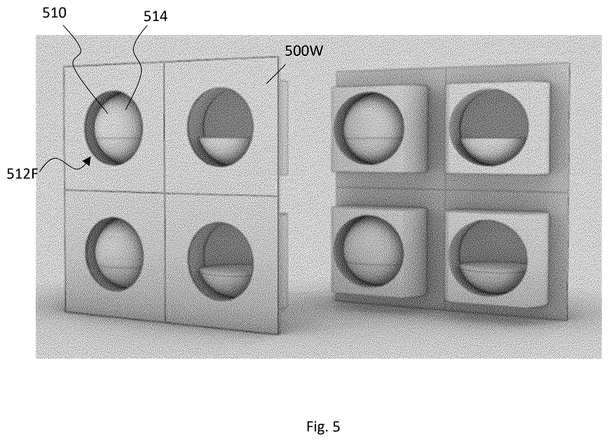

FIG. 5 shows an exemplary embodiment of the food container 510. Food container 510 may include the cover 514. Cover 514 may be adapted to turn to the front side 512F or the rear side (not shown in FIG. 5). As shown in FIG. 5, the food container 110 may be disposed within the wall 500W.

Food container 110 may include a control module configured to control the operation of the food container 110. Food container 110 may include a motor, e.g. stepper motor, adapted to actuate the cover 114 between the front side 112F and rear side 112R, the detector 120 configured to detect the presence of the customer's hand and/or food, and a communication unit configured to communicate with the processing unit 130, e.g. transmit a detecting signal to the processing unit 130. Food container 110 may include a heating element adapted to heat the food or a chilling element adapted to chill when in the food container 110 so that the food container 110 can keep the food warm or chilled while the food is in the container while waiting for the customer to collect it. Food container 110 may include a position sensor to sense the facing of the opening of the food container 110, i.e. if the food container 110 is opened toward the customer or the kitchen 304. Position sensor may be configured to sense the position of the cover 114, i.e. if the cover 114 is at the front side 112F, the processing unit 130 identifies the opening of the food container 110 or the food container 110 is facing the kitchen 304 and if the cover 114 is at the rear side 112R, the processing unit 130 identifies the opening of the fold container, or the food container 110 is facing the customer or the waiting area 302. Control module is configured to communicate with each of the above components, i.e. motor, detector 120, communication module 138, heating element, chilling element, position sensor, indicator, to operate the food container 110. Food container 110 may include a manual switch configured to overwrite the control by the processing unit 130. When the manual switch is turned on, the turning of cover 114 may be controlled manually. When the manual switch is turned off, the system 100 takes over the control of the food container 110 and the food container 110 may be re-initialized. Detector 120 may be an infra-red transceiver. Detector 120 may be configured to detect the presence of food in the food container 110.

System 100 may include a server, a laptop, a computer, etc. Processor 132 typically controls overall operations of the system 100, such as the operations associated with display, data communications. Processor 132 may include one or more processors to execute instructions in the above-described modules to perform all or part of the steps in the above-described methods. Moreover, the processor 132 may include one or more modules which facilitate the interaction between the processor 132 and other modules. System 100 may be in communication with the user devices via the network 150.

Memory 134 may be configured to store various types of data to support the operation of the system 100. For example, the data may include instructions for any applications or above methods operated on the system 100, programmes, applications, modules etc. Memory 134 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

Power source 139 provides power to various modules of the system 100. Power source 139 may include a power management system 100, one or more power sources, and any other modules associated with the generation, management, and distribution of power in the system 100.

Display 130D may include a screen providing an output interface for the system 100 and the user. In some embodiments, the screen may include a liquid crystal display (LCD), organic light-emitting diode (OLED), a touch panel, etc. If the screen includes the touch panel, the screen may be implemented as a touch screen to receive input signals from the user. Touch panel may include one or more touch sensors to sense touches, swipes, and gestures on the touch panel. The touch sensors may not only sense a boundary of a touch or swipe action, but also sense a period of time and a pressure associated with the touch or swipe action.

I/O interface 136 provides an interface between the processor 132 and peripheral interface modules, such as a keyboard, a click wheel, buttons, and the like. The buttons may include, but are not limited to, a home button, a volume button, a starting button, and a locking button.

Communication module 138 may be configured to facilitate communication, wired or wirelessly, between the system 100 and other devices, e.g. kitchen module, food container 110. System 100 may access a wireless network based on a communication standard, such as WiFi, 2G, or 3G, LTE, and 4G cellular technologies or a combination thereof. In one exemplary embodiment, the communication module 138 may receive a broadcast signal or broadcast associated information from an external broadcast management system 100 via a broadcast channel. In one exemplary embodiment, the communication module 138 may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the system 100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic modules, for performing the above described methods.

The present invention relates to a system 100 for delivering food to a customer and a method thereof generally as herein described, with reference to and/or illustrated in the accompanying drawings.

1. A system for delivering food to a customer, the system comprising:
a food container adapted to open on one side of the food container or another side opposite the one side,
a detector configured to detect that the food has been removed from the food container,
a processing unit comprising,
a processor,
a memory in communication with the processor, the memory for storing instruction executable by the processor, the processor is configured to,
receive an instruction from a customer's device to open the food container on the one side, wherein the one side faces the customer, wherein the customer is able to collect the food from the food container,
detect the food is removed from the food container, and
close the food container on the one side and open the food container on the another side automatically, wherein the another side faces a kitchen where food is placed into the food container from the kitchen.

2. The system according to claim 1, wherein the food container comprises a housing for containing the food, the housing comprises a cover adapted to be displaced from a front side of the housing to a rear side of the housing opposite the front side, wherein when the cover is at the front side of the housing, the food container is open at the another side of the food container and when the cover is at the rear side of the housing, the food container is open at the one side of the food container.

3. The system according to claim 1, wherein to detect the food is removed from the food container, the detector is configured to detect the presence of the customer's hand in the food container.

4. The system according to claim 1, wherein the detector is configured to detect the presence of the food in the food container.

5. The system according to claim 1, further comprising a heating element adapted to heat or a chilling element adapted to chill the food in the food container.

6. The system according to claim 1, wherein the processor is configured to close the food container after a pre-determined period of time.

7. A method for delivering food to a customer, the method comprising:
receiving an instruction from a customer's device to open a food container on a one side, wherein the one side faces the customer, wherein the customer is able to collect the food from the food container, wherein the food container adapted to open on the one side of the food container or another side opposite the one side,
detecting the food is removed from the food container, and
closing the food container on the one side and opening the food container on the another side automatically, wherein the another side faces a kitchen where food is placed into the food container from the kitchen.

8. The method according to claim 7, wherein the food container includes a housing for containing the food, the housing comprises a cover, wherein the method comprises displacing the cover from a front side of the housing to a rear side of the housing opposite the front side, wherein when the cover is at the front side of the housing, the food container is open at the another side of the food container and when the cover is at the rear side of the housing, the food container is open at the one side of the food container.

9. The method according to claim 7, wherein detecting the food is removed from the food container comprises detecting the presence of the customer's hand in the food container.

10. The method according to claim 7, wherein detecting the food is removed from the food container comprises detecting the presence of the food in the food container.

11. The method according to claim 7, further comprising heating or chilling the food in the food container.

12. The method according to claim 7, further comprising closing the food container after a pre-determined period of time.

13. A non-transitory computer readable storage medium comprising instructions, such that the instructions, when executed by a processor in a system, cause the system to:
receive an instruction from a customer's device to open the food container on the one side, wherein the one side faces the customer, wherein the customer is able to collect the food from the food container,
detect the food is removed from the food container, and
close the food container on the one side and open the food container on the another side automatically, wherein the another side faces a kitchen where food is placed into the food container from the kitchen.
